(19) United States
(12) Patent Application Publication
(10) Pub. No.: US 2026/0234924 A1
(43) Pub. Date: Aug. 13, 2026

(54) TELESCOPIC STRUCTURE

(71) Applicant: Clive GLASS, Ramsbury (GB)

(72) Inventor: Clive GLASS, Ramsbury (GB)

(21) Appl. No.: 19/155,268

(22) PCT Filed: Jan. 24, 2024
(86) PCT No.: PCT/GB2024/000003

§ 371 Date: Aug. 11, 2025

(30) Foreign Application Priority Data
Feb. 15, 2023 (GB) GB2302141.3

(51) Int. Cl. E04B 1/343; E04H 12/18; E06C 1/12

(52) U.S. Cl. CPC E04B 1/34312; E04H 12/182; E06C 1/12

(57) ABSTRACT

The invention is a system that enables telescopic structures to be constructed from extending elements that are all the same diameter, but when telescoped together all of them fit within the diameter of the bottom element. Extending structures can be joined together to form assemblies such as telescoping ladders and towers. The extension and contraction of the structure can be carried out manually or can be powered by hydraulic, pneumatic or mechanical devices.

### DESCRIPTION

Telescopic structures are typically constructed from tubes of different diameters that allow the tubes to fit inside one another. In the retracted condition the largest diameter tube in the assembly houses all the smaller tubes. The overall length of the closed assembly is reduced to the overall length of the largest tube plus the stacked length of the connections that are necessary to connect the tubes together.

Typical characteristics of this telescopic arrangement are:

Starting with the largest diameter tube, the diameter of each additional tube in the assembly must be progressively smaller for it to fit inside its mating part. This means that the overall stiffness and load bearing capability of the extended structure reduces as the length of the extended structure is increased.

When the structure is required to be rigid and to carry a load the size of the tubes is dictated by the stiffness and load bearing capacity of the smallest tube in the system. This can cause the biggest tube in the system to increase to a size where the overall weight of the assembly becomes difficult to handle.

If the pole is extended hydraulically or pneumatically the sections must be sealed to retain the fluid and the total internal volume of the pole must be filled\with fluid in order to fully extend the unit.

The invention is a method for constructing a telescopic structure where every section in the telescoping mechanism is the same diameter. However, the structure can “telescope” down to the point where the base section houses all of the other sections and the overall closed length is the length of the base section plus the stacked length of the connecting collars.

The telescopic structure can be extended manually, or by use of hydraulic or pneumatic cylinders that are housed inside the structure. However, the volume of such cylinders can be much smaller than the volume of the external telescoping structure which greatly reduces the volume of fluid required. Mechanical devices such as leadscrews and cables can also be utilised to expand and contract the structure.

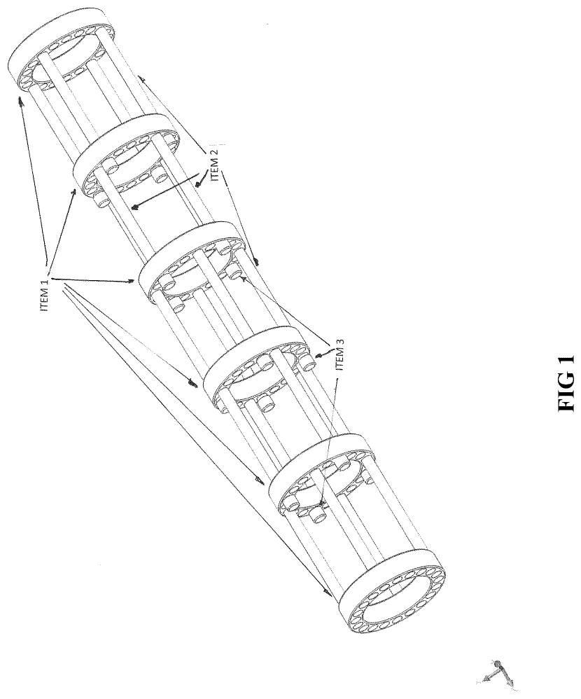

An-embodiment of the invention will now be described with reference to the accompanying FIGS. 1 to 5

The system is comprised of 3 components:
Circular Collars (FIG. 1 Item 1) that have a series of holes that are arranged radially around a common centre-point. The diameter of the collar, the diameter of the holes, and the number of holes will vary according to the design specification of individual structures.
Connecting Rods (FIG. 1 Item 2) that connect the Circular Collars in the overall structure and provide the required rig, idity and load bearing capacity of the structure.
Mechanical Stops (FIG. 1 Item 3) that retain the Connecting Rods at the end of their extension.

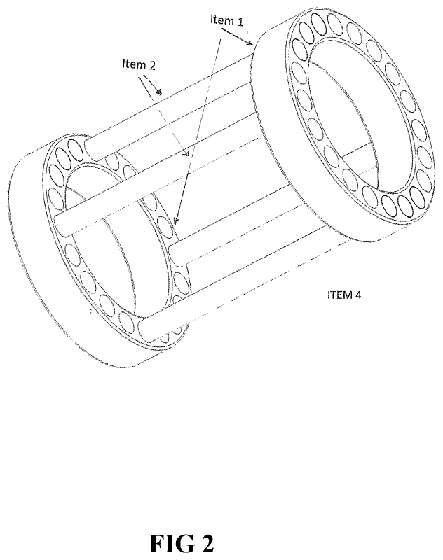

The description of the Assembled Structure (FIG. 1) is that for an example that extends to five elements and is comprised of a Base Element (FIG. 2 Item 4) and 4 Extending Elements (FIG. 2 Item 5). Each of the 5 Elements has 4 Connecting Rods and that requires 20 radial holes in the Circular Collars.

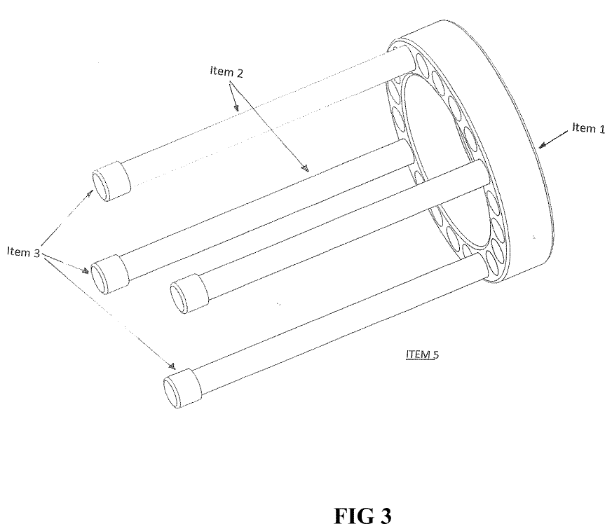

On assembly of the structure Items 1 and 2 are used to construct two different assemblies:
A Base Element (FIG. 2 Item 4) that comprises two Collars and the Connecting Rods that are locked into the collars at each end of the Connecting Rods.
An Extending Element (FIG. 3 Item 5) in which 4 Connecting Rods are locked into a single collar.

On final assembly of the extending structure the rods of Extending Element number 1 are Inserted through the top collar of the Base Element with each rod one position out of phase with the rods that are already fixed into the top collar of the Base Element. The connecting rods of Extending Element Number 2 are inserted through the top collar of Extending Element Number 1 with each rod one position out of phase with the rods fixed into Extending Element Number 1. This process is repeated for Extending Elements 3 and 4. When all of the Extending Elements are in position the Mechanical Stops (FIG. 1 Item 3) are fixed to the ends of each connecting rod.

With the elements fully assembled each of the Extending Elements can be pulled out until the fixed Mechanical Stops contact the underside of the Top Collar of the element below it at which point the pole assembly is fully extended.

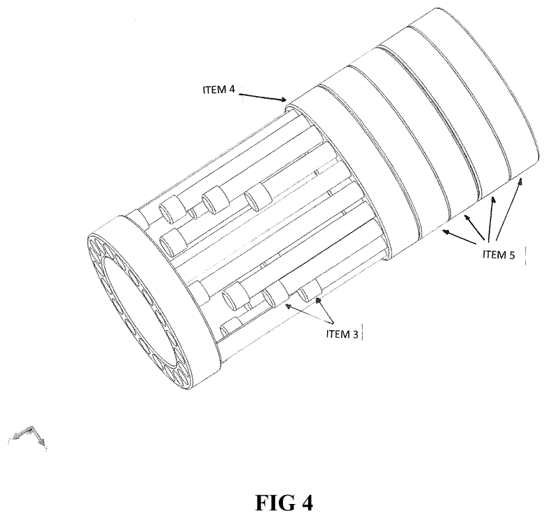

To retract the pole each of the Extending Elements is driven downwards until the Top Collar of each element meets the top collar of the element below it and all of the Extending Elements are pushed into the Base Element. The Top Collars are stacked on top of each other at the top of the Base Element. (FIG. 4)

The system is very adaptable because the diameter of the collars, the diameter of the rods, the number of rods per element, and the number of elements in the overall structure can be varied in accordance with the operating requirements of the system. For example a six element structure, with 4 rods per element determines that there will be 24 radial holes in the collars. The load bearing capability of the structure determines the required diameter of the rods, which in turn determines the radius of the collar needed to accommodate the holes.

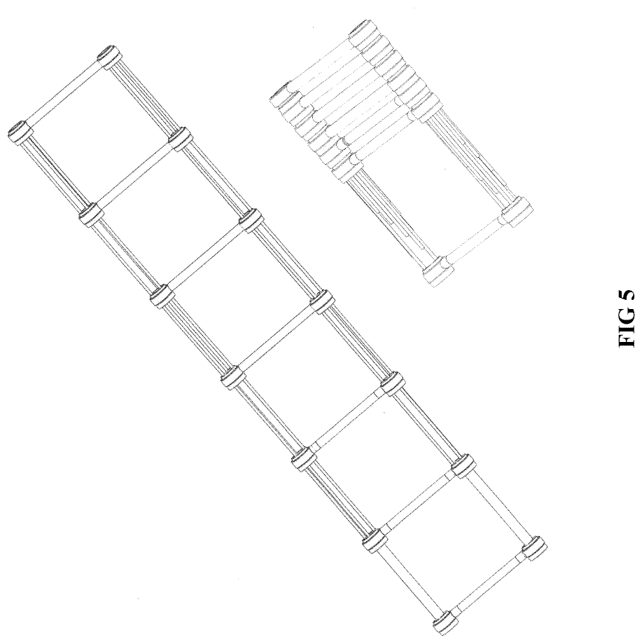

Extending structures can be joined together to form structures such as telescoping ladders {FIG. 5) and towers.

The collars and rods can be made in a variety of different materials that include metals, plastic, composites, wood or paper.

The collars can vary in shape. As well as circular, they can be configured as triangles, squares or polygons.

The rods can also be varied in shape.

What is claimed is:

1. A telescopic structure comprising:
base element comprising of two base collars comprising a plurality of holes arranged circumferentially about a central axis, and a plurality of base connecting rods to which the base collars are fixed at each end of the base connecting rods;
a plurality of extending elements each of which comprises of an extending collar comprising a plurality of holes arranged circumferentially about a central axis, and extending connecting rods that are fixed to the extending collar at one end of each extending connecting rod; and
one or more mechanical stops fixed to the ends of the extending connecting rods of the extending elements after the extending elements and the base elements are assembled together.

2. The telescopic structure according to claim 1, wherein each of the base element and the extending elements are of the same diameter, and wherein, in the retracted condition, the extending elements are configured to be housed within the base element with the extending collars of the extending elements arranged in series along a longitudinal axis of the base element.

3. The telescopic structure according to claim 1, wherein the base collars and the extending collars are configured to be dimensioned with diameter determined according to the requirements of the telescopic structure.

4. The telescopic structure according to claim 1, wherein the number of the base connecting rods and the extending connecting rods of the base element and the extending element is determined according to the requirements of the telescopic structure.

5. The telescopic structure according to claim 1, wherein the diameter of the base connecting rods and the extending connecting rods of each of the base element and the extending element is determined according to the requirements of the telescopic structure.

6. The telescopic structure according to claim 1, wherein the number of extending elements in the telescopic structure is determined according to the requirements of the telescopic structure.

7. The telescopic structure according to claim 1, wherein the base collar, the extending collar, the base connecting rods and the extending connecting rods are made from a range of different materials comprising of metals, plastics, composites, wood, and paper.

8. The telescopic structure according to claim 1, wherein the telescopic structure is configured to be extended and retracted manually or by incorporating internal operating mechanisms.

9. The telescopic structure according to claim 1, wherein plurality of telescopic structures are configured to be connected by joining pieces to form telescopic ladders, platforms and towers.
